(19) United States
(12) Patent Application Publication
(10) Pub. No.: US 2021/0120008 A1
(43) Pub. Date: Apr. 22, 2021

(54) APPARATUS, METHOD, AND RECORDING MEDIUM

(71) Applicant: YOKOGAWA ELECTRIC CORPORATION, Tokyo (JP)

(72) Inventor: Keisuke SAWADA, Tokyo (JP)

(21) Appl. No.: 17/134,466

(22) Filed: Dec. 27, 2020

Related U.S. Application Data
(63) Continuation of application No. PCT/JP2019/028179, filed on Jul. 17, 2019.

(30) Foreign Application Priority Data
Jul. 24, 2018 (JP) 2018-138410

(51) Int. Cl. H04L 29/06

(52) U.S. Cl. CPC H04L 63/105; H04L 67/12

(57) ABSTRACT

Simply making a plurality of services cooperate with each other causes insufficiency in terms of ensuring of security in some cases if there are different service providers or in other cases, for example. An apparatus is provided, the apparatus including: a storage unit that, for each of instances of a plurality of execution logics to execute a service, stores a right to access a resource allocated to the instance; and an access control unit that allows each instance to access the resource within a range of the access right.

### CROSS-REFERENCE TO RELATED APPLICATION

This is a continuation application of International Application No. PCT/JP2019/028179, filed on Jul. 17, 2019, which claims priority to Japanese Patent Application No. 2018-138410, filed on Jul. 24, 2018, the contents of each of which are incorporated herein by reference.

### BACKGROUND

### 1. Technical Field

The present invention relates to an apparatus, a method, a program, and a recording medium.

### 2. Related Art

In recent years, the Internet of Things (IoT) and Industrial IoT (IIoT) have drawn attention, and systems in which numerous sensors are distributed to perform measurement, monitoring, and the like are increasingly deployed as cloud computing systems. For example, Patent Literature 1 discloses a system and method related to use of cloud computing in industrial applications.

Patent Literature 1: Japanese Translation of PCT International Application Publication No. 2012-523038

### SUMMARY

In view of such a circumstance, if a plurality of services are provided on a network, it is conceivable that a plurality of services are caused to cooperate with each other. However, simply making a plurality of services cooperate with each other causes insufficiency in terms of ensuring of security in some cases if there are different service providers or in other cases, for example.

In order to overcome drawbacks mentioned above, a first aspect of the present invention provides an apparatus. The apparatus may include a storage unit that, for each of instances of a plurality of execution logics to execute a service, stores a right to access a resource allocated to the instance. The apparatus may include an access control unit that allows each instance to access the resource within a range of the access right.

A second aspect of the present invention provides a method. The method may include, for each of instances of a plurality of execution logics to execute a service, storing a right to access a resource allocated to the instance. The method may include allowing each instance to access the resource within a range of the access right.

A third aspect of the present invention provides a program. The program may make a computer function as a storage unit that, for each of instances of a plurality of execution logics to execute a service, stores a right to access a resource allocated to the instance. The program may make the computer function as an access control unit that allows each instance to access the resource within a range of the access right.

A fourth aspect of the present invention provides a recording medium having recorded thereon a program. The program may make a computer function as a storage unit that, for each of instances of a plurality of execution logics to execute a service, stores a right to access a resource allocated to the instance. The program may make the computer function as an access control unit that allows each instance to access the resource within a range of the access right.

The summary clause does not necessarily describe all necessary features of the embodiments of the present invention. The present invention may also be a sub-combination of the features described above.

### BRIEF DESCRIPTION OF DRAWINGS

FIG. 1 illustrates a system 1 according to the present embodiment.

FIG. 2 illustrates an application database 601.

FIG. 3 illustrates a role database 603.

FIG. 4 illustrates a role-right table 604.

FIG. 5 illustrates a logic database 605.

FIG. 6 illustrates a method of setting an access right.

FIG. 7 illustrates a service providing method.

FIG. 8 illustrates an exemplary aspect in which access to a resource is allowed.

FIG. 9 illustrates another exemplary aspect in which access to a resource is allowed.

FIG. 10 illustrates an exemplary computer 2200 with which multiple aspects of the present invention may be entirely or partially embodied.

### DESCRIPTION OF EXEMPLARY EMBODIMENTS

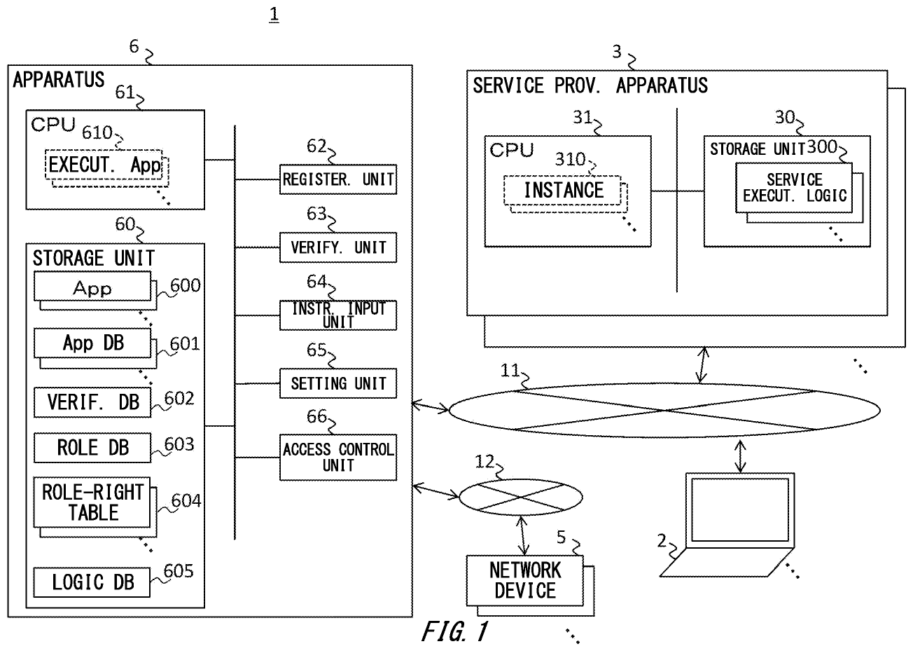

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

[1. System 1] FIG. 1 illustrates a system 1 according to the present embodiment. The system 1 includes a network 11, one or more client terminals 2, one or more service providing apparatuses 3, a network 12, one or more network devices 5, and an apparatus 6.

[1-1. Network 11] The network 11 establishes wireless or wired connections between the client terminals 2, the service providing apparatuses 3, and the apparatus 6. The network 11 may be the internet, a wide area network, a local area network, or the like, and may include a mobile network.

[1-2. Client Terminals 2] A client terminal 2 is used by a user of a service provided by a service providing apparatus 3. For example, the client terminal 2 is a PC (personal computer), a tablet computer, a smartphone, a workstation, a server computer, or a computer such as a general purpose computer.

[1-3. Service Providing Apparatuses 3] A service providing apparatus 3 is operated by a service provider, and provides one or more services to another instrument (e.g., a client terminal 2). For example, the service providing apparatus 3 is a server computer, but may be a cloud computer. Here, services are information processing, instrument control, and the like that the service providing apparatus 3 provides to a user or another instrument (e.g., a client terminal 2), and for example may be at least one of conversion of data into graphs, analysis of data (e.g., calculation of characteristic values such as average values, highest values, or lowest values, and calculation of KPIs (Key Performance Indicators)), machine learning, and the like. The service providing apparatus 3 has a storage unit 30 and a CPU 31.

[1-3-1. Storage Unit 30] The storage unit 30 has one or more execution logics 300 for providing services. An execution logic may be a service providing program or the like describing processing details, a procedure, a method or the like of a service.

[1-3-2. CPU 31] The CPU 31 generates therein an instance 310 of an execution logic 300. The CPU 31 may generate the instance 310 upon receiving a request from a service user. Here, in the present embodiment, for example, the instance 310 is one obtained by deploying the execution logic 300 on a main memory, and made ready for processing and execution. Different instances 310 may be associated with different combinations of an execution logic 300 and a user account that causes the execution logic 300 to be executed. The CPU 31 may generate a plurality of instances 310 by executing one execution logic 300 in parallel, or may generate a plurality of instances 310 by executing a plurality of execution logics 300 in parallel.

[1-4. Network 12] The network 12 establishes wireless or wired connections between network devices 5 and the apparatus 6. The network 12 may be the internet, a wide area network, a local area network, or the like, and may include a mobile network. Although, in this figure, the network 11 and the network 12 are separate networks, instead of this the network 11 and the network 12 may be a single network.

[1-5. Network Device 5] A network device 5 is a field instrument, a sensor or the like that can be connected to the network 12, or a gateway, a hub or the like provided between such an instrument and the network 12. Here, the field instrument, sensor or the like may be an implement, machine or apparatus (for example may be a sensor that measures a physical quantity such as pressure, temperature, pH, speed, or flow rate in processes at facilities, may be an actuator such as a valve, flow rate control valve, on-off valve, pump, fan, or a motor that controls any of the physical quantities, may be an image-capturing instrument such as a camera or a video camera that captures images of conditions or target objects in facilities, may be an audio instrument such as a microphone or a speaker that collects abnormal sound or the like in facilities or emits warning sound or the like, may be a position-detecting instrument that outputs positional information of each instrument, or may be another instrument). The network device 5 may transmit a process value to the apparatus 6, or may receive a control signal from the apparatus 6, and be driven based on the control signal.

[1-6. Apparatus 6] The apparatus 6 allows a service provided by a service providing apparatus 3 to access a resource of the apparatus 6. For example, the apparatus 6 is a cloud computer, and has a storage unit 60, a CPU 61, a registering unit 62, a verifying unit 63, an instruction input unit 64, a setting unit 65, and an access control unit 66.

[1-6-1. Storage Unit 60] The storage unit 60 has one or more applications 600, one or more application databases 601, a verification database 602, a role database 603, one or more role-right tables 604, and a logic database 605.

[1-6-1(1). Application Databases 601] An application database 601 is a database in which read-out and write-in of data is performed by an application 600. In the present embodiment, for example, an application database 601 is provided for each application 600.

[1-6-1(2). Applications 600] An application 600 is a program executed for a particular function. For example, the application 600, when executed, may acquire values obtained by measurement by a network device 5 as a sensor and store the values in an application database 601, and may read out measurements from the application database 601, and supply them to another instrument. In addition, the application 600, when executed, may execute data analysis on data in the application database 601, and may supply results of the analysis to another instrument. In the present embodiment, each application 600 utilizes a service executed by an execution logic 300.

[1-6-1(3). Verification database 602] The verification database 602 stores user verification information for verifying a user account of the apparatus 6 in association with the user account. The verification database 602 may store logic verification information for verifying each execution logic 300 of a plurality of execution logics 300 in association with a logic account allocated to an instance 310 of the execution logic 300.

[1-6-1(4). Role Database 603] The role database 603 cooperates with the role-right tables 604, and stores, for each of instances 310 of execution logics 300, a right to access a resource allocated to the instance 310 by the apparatus 6. In the present embodiment, for example, the role database 603 stores an access right as a role. A role of an access right may be a group of access rights.

Here, a resource allocated to an instance 310 by the apparatus 6 may be a resource which is at least some of resources of the apparatus 6, and may be a resource allocated by a user of the apparatus 6, for example. Resources of the apparatus 6 are elements or instruments to be utilized in operation of the apparatus 6, and may be provided to the apparatus 6, or may be externally connected to the apparatus 6. For example, resources may be at least one of the application databases 601, the one or more network devices 5, and an application 600 itself. Resources may be at least some configurations of a service providing apparatus 3.

[1-6-1(5). Role-Right tables 604] A role-right table 604 stores an access right set for each role of an access right. An access right may indicate whether or not at least one of a right to read out data from a resource, a right to write data in a resource, and a right to change settings of a resource is given. In the present embodiment, for example, an access right set for a role is different for each application 600, and, although a role-right table 604 is provided for each application 600, only one role-right table 604 may be provided for a plurality of applications 600.

[1-6-1(6). Logic Database 605] For each logic account allocated to an instance 310 of an execution logic 300, the logic database 605 stores details of the execution logic 300.

[1-6-2. CPU 61] The CPU 61 executes an application 600, and generates therein an execution application 610 which is an instance of the application 600. Different execution applications 610 may be associated with different combinations of an application 600 and a user account to make the application 600 executed. An execution application 610 may be able to call an instance 310 of an execution logic 300.

[1-6-3. Registering Unit 62] The registering unit 62 registers instances 310 of execution logics 300. In the present embodiment, for example, the registering unit 62 allocates a logic account to an instance 310 of an execution logic 300, and registers the logic account in the role database 603, and the logic database 605. In addition, the registering unit 62 registers details of an execution logic 300 in the logic database 605 in association with a logic account.

[1-6-4. Verifying unit 63] The verifying unit 63 performs verification of each of logic accounts allocated to instances 310 of a plurality of execution logics 300. In addition, the verifying unit 63 performs verification of a user account associated with a resource of the apparatus 6. The verifying unit 63 may perform the verification by referring to the verification database 602. Here, a user account associated with a resource may be an account of a user (also referred to as an owner user of the resource) who is an owner, an administrator or a contributor (e.g., a creator) of the resource.

[1-6-5. Instruction Input Unit 64] The instruction input unit 64 receives a setting instruction about a right for access by an instance 310 to a resource. The setting instruction may be input by an owner user of the resource. The instruction input unit 64 may supply the setting instruction to the setting unit 65.

[1-6-6. Setting unit 65] The setting unit 65 sets the right to access the resource for the instance 310 according to the setting instruction. For example, the setting unit 65 stores, in the role database 603, a role of the access right in association with a logic account of the instance 310. In addition to this, the setting unit 65 may store, in the role-right table 604, the access right of the registered role.

[1-6-8. Access Control Unit 66] The access control unit 66 allows each instance 310 to access a resource within the range of an access right stored in the role database 603 and role-right table 604. The access control unit 66 may allow access within the range of an access right set for a role associated with a logic account in the role database 603. The access control unit 66 may allow an instance 310 of a logic account that is successfully verified by the verifying unit 63 to access a resource.

According to the system 1 explained above, a right to access a resource (e.g., an application database 601) is stored for each of instances 310 of a plurality of execution logics 300, and each instance 310 is allowed to access a resource within the range of the access right, so cooperation between services becomes possible while ensuring the resource security of the apparatus 6. In addition, since instances 310 are different for different combinations of execution logics 300, and user accounts to make the execution logics 300 executed, the security can be further enhanced by setting an access right different for each user account.

In addition, an access right indicates whether or not at least one of a right to read out data from a resource, a right to write data in a resource, and a right to change settings of a resource is given, the security of services can be surely ensured by setting an appropriate access right. In addition, since an access right is stored as a role in the storage unit 60, and an instance 310 is allowed to access within the range of the access right corresponding to the role, setting can be made easy to perform as compared with the case where access rights are set individually for instances 310.

In addition, since verification of each of logic accounts is performed, and an instance 310 of a successfully verified logic account is allowed to access a resource, the resource security can be further enhanced.

In addition, since the storage unit 60 stores applications 600 to utilize services to be executed by execution logics 300, cooperation between the applications 600 and one or more services is realized.

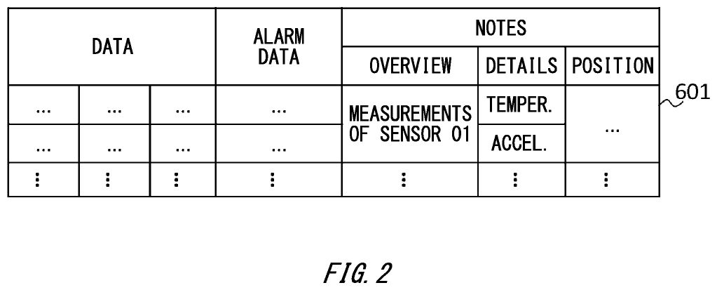

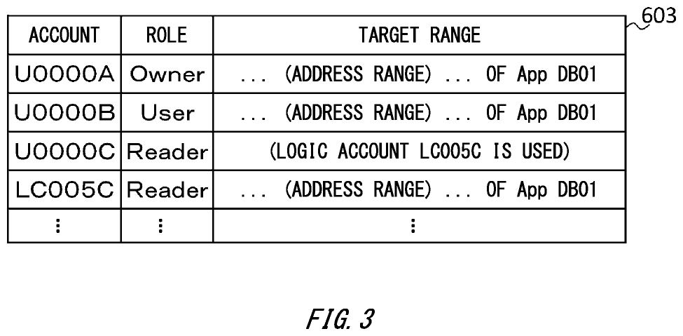

In addition, since an instance 310 of an execution logic 300 for a service is registered, and a right for access by the instance 310 to a resource is set according to a setting instruction from an owner user of the resource, cooperation between services becomes possible while ensuring the resource security at any security level as desired by the owner user of the resource. In addition, since an access right is set according to a setting instruction from a user of a successfully verified user account, the resource security can be surely ensured.

[2. Specific Example of Application Databases 601] FIG. 2 illustrates an application database 601. A corresponding application 600 reads out data from the application database 601, and writes data in the application database 601. In this figure, for example, the application database 601 stores time series data about temperature and acceleration measurements acquired from a network device 5 such as “Sensor 01”, and alarm data such as errors about individual pieces of time series data. The application database 601 may further store an installation position of each sensor, that is, a measurement position.

[3. Specific Example of Role Database 603] FIG. 3 illustrates the role database 603. The role database 603 stores a role of an access right about each of instances 310. For example, the role database 603 stores a role of an access right, and an applicable range of the access right in association with each other, for each user account of the apparatus 6, and for each logic account of an instance 310. The applicable range may indicate a resource of the apparatus 6 allocated to an instance 310 of an execution logic 300. For example, the applicable range further include an address range of resources of the apparatus 6 about at least one of the right to read out data, and the right to write data. This address range may indicate, for example, a storage area of the latest data, a storage area of the N-th latest data (N is an integer larger than 1), a storage area of data in a predetermined time window, or the like. Thereby, the security of the apparatus 6 is more surely ensured.

In this figure, for example, the role database 603 stores the address range of a resource ID “App DB01” as an applicable range of an access right, in association with user accounts “U0000A” and “U0000B”, and a logic account “LC005C”, and with roles of access rights “Owner” (owner), “User” (user), and “Reader” (reader). Here, “Owner” may be a role set for at least one owner of the apparatus 6, an application 600, and a resource thereof “User” may be a role set for an engineer or the like who performs maintenance of an application 600, and a resource thereof. “Reader” may be a role set for a user of an application 600. Note that the types of roles are not limited thereto, but may be “Administrator” (administrator) set for an administrator of at least one of an application 600 and a resource thereof, “Contributor” (contributor) set for a contributor (e.g., a provider, and a creator) of at least one of an application 600 and a resource thereof, or the like.

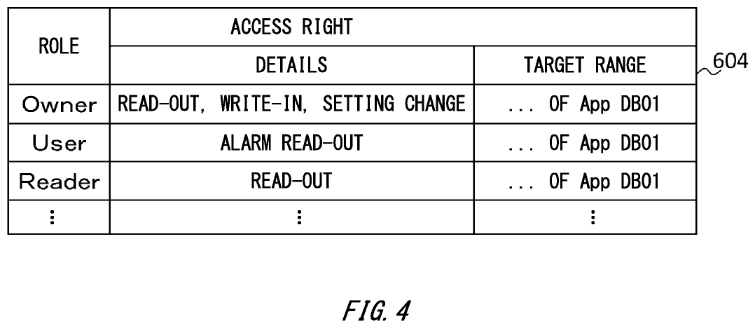

Note that for a user account that accesses a resource of the apparatus 6 indirectly via an instance 310 of an execution logic 300 without directly using a resource of the apparatus 6, a logic account of an instance 310 may be associated therewith, instead of storage of an applicable range of an access right. In this figure, for example, the role database 603 stores the logic account “LC005C” in association with the user account U0000C of a service user who generated the instance of the logic account “LC005C”.

[4. Specific Example of Role-Right Tables 604] FIG. 4 illustrates a role-right table 604. The role-right table 604 stores details of an access right, and an applicable range that are set for each role of an access right.

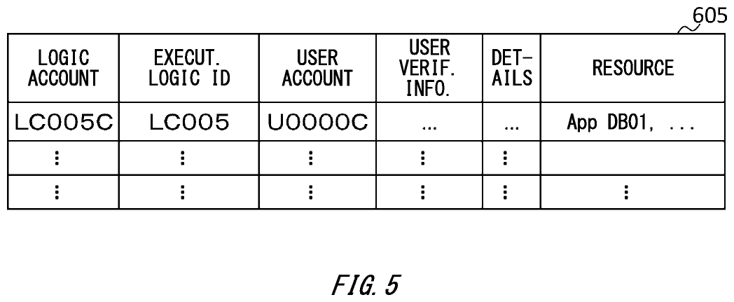

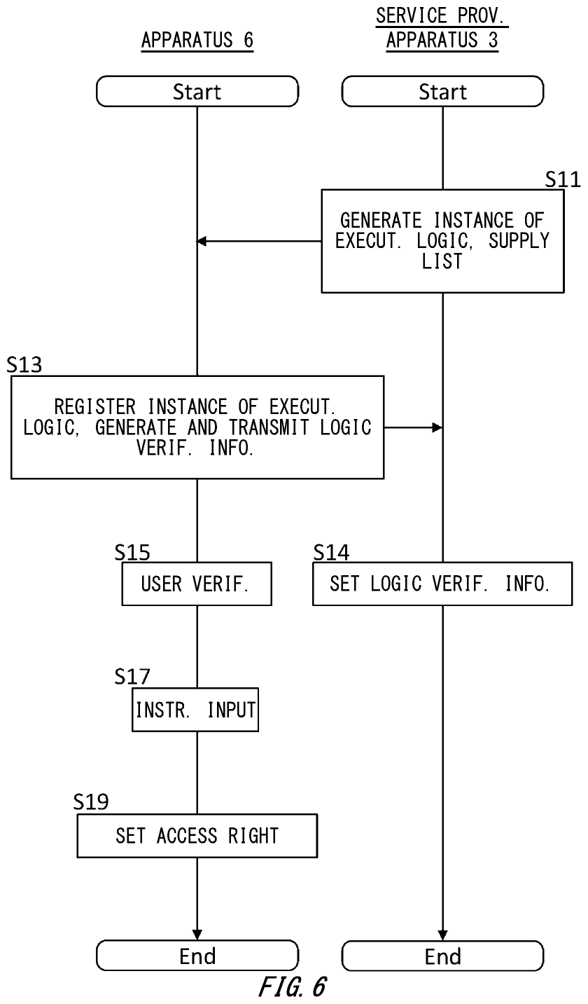

In this figure, for example, the role-right table 604 stores “read-out”, “write-in”, “setting change”, and the like as details of an access right of the role “Owner”, stores “read-out” as an access right of the role “Reader”, stores “alarm read-out” as an access right of the role “User”, and stores an address range of the resource ID “App DB01” as an applicable range of each role. Here, “read-out” indicates that a role is given a right to read out data from a resource, “write-in” indicates that a role is given a right to write data in a resource, “setting change” indicates that a role is given a right to change the settings of a resource, and “alarm read-out” indicates that a role is given a right to read out alarm data such as an error from a resource.

[5. Specific Example of Logic Database 605] FIG. 5 illustrates the logic database 605. For each logic account allocated to an instance 310 of an execution logic 300, the logic database 605 stores details of the execution logic 300. Details of an execution logic may be at least one of processing details, details of input data, and details of output data (e.g., the type, number of pieces or the like of data). For each logic account, the logic database 605 may further store an ID of an execution logic 300, a user account that a user of a service to be executed by an execution logic 300 uses for the apparatus 6, user verification information that a service user uses for a service providing apparatus 3 (e.g., a login ID and a password), a resource of an application 600 that utilizes a service to be executed by an execution logic 300, and the like. In this figure, for example, the logic database 605 stores the execution logic ID “LC005”, the user account “U0000C”, user verification information, details of an execution logic, the application resource ID “App DB01”, or the like in association with the logic account “LC005C”.

[6. Setting of Access Right] FIG. 6 illustrates a method of setting an access right. The system 1 performs processes at Steps S11 to S19 to thereby set a right to access resources of the apparatus 6 for individual instances 310 of one or more execution logics 300.

At Step S11, in response to manipulation by a service user via a client terminal 2, a CPU 31 of a service providing apparatus 3 generates instances 310 of at least one execution logic 300 to be caused to cooperate with applications 600 (also referred to as cooperation target applications 600) in the apparatus 6, and supplies a list of the instances 310 to the apparatus 6. The cooperation target applications 600 may be some of applications 600 of the apparatus 6 that are selected by a service user, or may be all the applications 600 of the apparatus 6 that are selected automatically. If a plurality of instances 310 are generated, a single application 600 may be selected as a cooperation target application 600, or different applications 600 may be selected as cooperation target applications 600.

The CPU 31 may make the list public on a network, and request the apparatus 6 to acquire the list, or may transmit the list to the apparatus 6. The list of instances 310 may include an ID and details of an execution logic 300 for each instance 310, a user account that a service user has for the apparatus 6, and user verification information that the service user has for a service providing apparatus 3. The user account that the service user has for the apparatus 6 may be the same as or may be different from a user account of an owner user of a resource. Details of execution logics 300 included in the list may be programs of the execution logics 300. Note that if only some of a plurality of execution logics 300 stored in the service providing apparatus 3 are selected by a service user as targets to cooperate with applications 600, the list may include only information about instances 310 of the selected execution logics 300.

At Step S13, the registering unit 62 of the apparatus 6 allocates a logic account to an instance 310 included in the supplied list, and stores the logic account and the details of the execution logic 300 in the logic database 605 to thereby register the instance 310. In the present embodiment, for example, the registering unit 62 stores, in the logic database 605, a logic account, an ID of an execution logic 300, a user account that a service user of the execution logic 300 has for the apparatus 6, user verification information that the service user has for the service providing apparatus 3, details of the execution logic 300, and a resource of a cooperation target application 600, in association with each other. In addition, the registering unit 62 registers the logic account in the role database 603.

In addition, the registering unit 62 generates logic verification information for the apparatus 6 to verify an instance 310 (e.g., an ID and a password for logging in to the apparatus 6), and registers them in the verification database 602 in association with a logic account. In addition, the registering unit 62 transmits the logic account and logic verification information to each service providing apparatus 3 that is the transmitter of the list at Step S11.

At Step S14, the service providing apparatus 3 stores, in the storage unit 30, the transmitted logic account and logic verification information in association with each other.

At Step S15, the verifying unit 63 of the apparatus 6 performs verification of a user account about an owner user of a resource. For example, the verifying unit 63 makes the owner user input user verification information (e.g., an ID and a password for logging in to the apparatus 6), and performs verification by checking whether or not it matches the user verification information stored in the verification database 602. In response to a verification result indicating successful verification, the verifying unit 63 allows logging in to a user account corresponding to the login ID. Processes after this up to Step S19 are performed while the user is logged in. In the present embodiment explained, for example, the owner user of a resource is one person, but there may be a plurality of persons. If there are a plurality of owner users of a resource, processes at and after Step S15 may be performed by each owner user. Note that input by an owner user of a resource may be directly performed into the apparatus 6, or may be performed into the apparatus 6 via another instrument such as a client terminal 2.

At Step S17, the instruction input unit 64 of the apparatus 6 receives, from an owner user of a resource of the apparatus 6, an instruction to set a right for access by a registered instance 310 to the resource. In the present embodiment, for example, the instruction input unit 64 receives a role of an access right, and an instruction to set an applicable range of the access right. If a plurality of instances 310 are registered, the instruction input unit 64 may receive a setting instruction for each instance 310.

At Step S19, the setting unit 65 of the apparatus 6 sets the right to access the resource for each instance 310 according to the setting instruction. For example, the setting unit 65 stores a role, and an applicable range of an access right in association with a logic account of an instance 310 registered in the role database 603. In addition, the setting unit 65 stores an access right of a role in a role-right table 604. In the present embodiment, for example, a role and details of an access right are stored in advance in the role-right table 604 in association with each other, and the setting unit 65 stores an applicable range of an access right of a role in the role-right table 604 according to a setting instruction. Thereby, a right to access a resource allocated to each instance 310 is stored. Note that an applicable range of an access right in the role-right table 604 may be used as a master to be used in setting an applicable range in the role database 603, and may indicate a settable broadest applicable range. In this case, according to a setting instruction, the setting unit 65 may store, in the role database 603, at least some of applicable ranges of access rights stored in the role-right table 303 as applicable ranges of access rights for instances 310.

Note that the setting unit 65 may set different access rights for different instances 310. The setting unit 65 may set an access right according to at least one of details of execution logics 300 registered in the logic database 605, and resources of applications 600. For example, the setting unit 65 may set “Reader” as a role of a logic account of an execution logic 300 to extract at least partial data from a resource and accumulate the data (e.g., an execution logic 300 to perform storage of particular data) or an execution logic 300 to read out data from a resource, and outputs the data to an instrument different from the apparatus 6 (e.g., an execution logic 300 to perform conversion of data into a graph, and analysis of data). In addition, the setting unit 65 may set an application database 601 included in a resource as an applicable range of an access right.

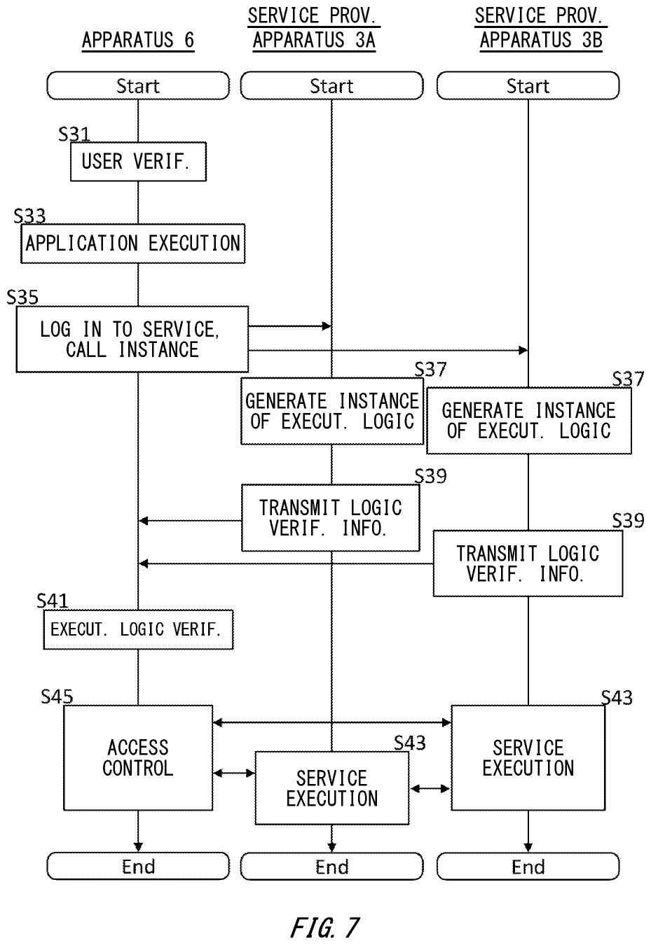

In addition, although, in this figure, for example, the method explained sets a right to access a resource for an instance 310 of an execution logic 300, an access right may be set for a service user. In this case, according to an instruction to set an access right from a successfully verified owner user of a resource, the setting unit 65 may set an access right in association with a user account of a service user.

[7. Providing Service] FIG. 7 illustrates a service providing method. The system 1 performs processes at Steps S31 to S45 to thereby access a resource of the apparatus 6, and provide a service by using an execution logic 300. Note that although, in this figure, for example, the system 1 provides services, in cooperation with each other, by using different instances 310 that are generated by two service providing apparatuses 3 (also referred to as service providing apparatuses 3A, 3B), the number of instances 310 may be one or three or larger. For example, an instance 310 (also referred to as an instance 310A) generated at the service providing apparatus 3A may provide a data analysis service. In addition, an instance 310 (also referred to as an instance 310B) generated at the service providing apparatus 3B may provide a storage service of extracting partial data from a particular network device 5 and accumulating it.

At Step S31, the verifying unit 63 of the apparatus 6 performs verification of a user account for a service user, and makes the service user log in to the user account, similar to Step S15 mentioned above. Processes after this up to Step S45 are performed while the user is logged in to the user account of the apparatus 6. Note that input by a service user may be directly performed into the apparatus 6, or may be performed into the apparatus 6 via another instrument such as a client terminal 2.

At Step S33, according to manipulation by a service user, the CPU 61 executes a cooperation target application 600, and generates therein an execution application 610.

At Step S35, according to manipulation by a service user, the CPU 61 logs in to services to be provided by one or more service providing apparatuses 3 (in the present embodiment, for example, the two service providing apparatuses 3A, 3B). In addition, according to manipulation by a service user, the execution application 610 calls instances 310 (in the present embodiment, for example, two instances 310A, 310B) of one or more execution logics 300.

The CPU 61 may read out user verification information that a service user has for each service providing apparatus 3 from the logic database 605, and perform logging-in, and processes after this up to Step S45 are performed while the user is logged in to a user account of each service providing apparatus 3. Note that if user verification information is not stored in the logic database 605, the CPU 61 may make a service user input user verification information, make the service providing apparatus 3 perform verification, and allow logging in to a user account according to successful verification.

At Step S37, the CPU 31 of each service providing apparatus 3 into which logging-in has been performed executes each execution logic 300 that is called, and generates therein an instance 310. In the present embodiment, for example, the service providing apparatus 3A generates the instance 310A, and the service providing apparatus 3B generates the instance 310B.

At Step S39, each instance 310 (in the present embodiment, for example, the instances 310A, 310B) of each service providing apparatus 3 transmits, to the apparatus 6, logic verification information (e.g., an ID and a password for logging in to the apparatus 6) stored in the storage unit 30 in association with a logic account allocated to the instance.

At Step S41, the verifying unit 63 of the apparatus 6 performs verification of each transmitted logic account. For example, the verifying unit 63 performs verification to check whether or not the transmitted logic verification information and logic verification information stored in the verification database 602 match, and, in response to a verification result indicating successful verification, causes logging in to a logic account to be performed. Processes after this up to Step S45 are performed while the user is logged in to the apparatus 6.

At Step S43, each instance 310 of a successfully verified service providing apparatus 3 executes a service while accessing a resource of the apparatus 6. When accessing a resource, an instance 310 may transmit an access request including a logic account of itself to the resource, and perform access in response to being permitted to perform access by the access control unit 66.

At Step S45, the access control unit 66 allows each instance 310 to access a resource within the range of its access right. Every time an access request is given by an instance 310, the access control unit 66 may refer to the role database 603, identify a role corresponding to a logic account included in the access request, and its applicable range of an access right, refer to a role-right table 604 to identify details of an access right corresponding to the role, and judge whether requested access is within the range of the access right. The applicable range of an access right may include a resource (e.g., the service providing apparatus 3B) externally connected to the apparatus 6. Provided that access by the instance 310 is within the range of an access right, the access control unit 66 may allow access by the instance 310. Thereby, access is allowed within the range of an access right corresponding to the role. Note that, instead of judging whether access is within the range of an access right every time access occurs, the access control unit 66 may make a resource accessible in advance within the range of an access right.

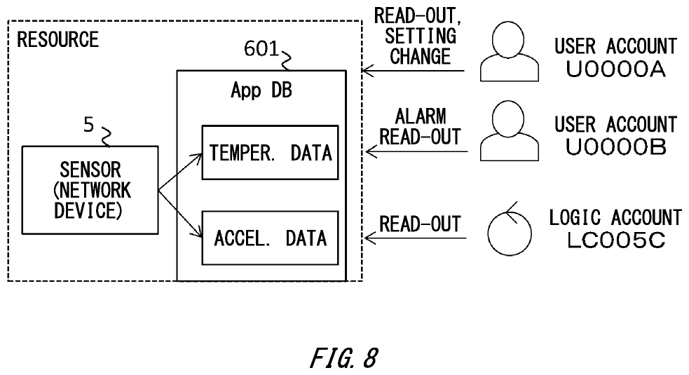

According to the operations explained above, services can be caused to cooperate with each other while ensuring the resource security of the apparatus 6. For example, if the instance 310A to provide a data analysis service accesses the service providing apparatus 3B in order to read out storage data of the instance 310B, the access control unit 66 judges that the access is within the range of an access right, and access is allowed. Thereby, the data analysis service provided by the instance 310A and the data storage service provided by the instance 310B are caused to cooperate with each other.

[7-1. Specific Example (1)] FIG. 8 illustrates an exemplary aspect in which access to a resource is allowed. In this figure, for example, the resource has a network device 5 as a sensor to acquire temperature and acceleration measurements, and an application database 601 that stores the measurements.

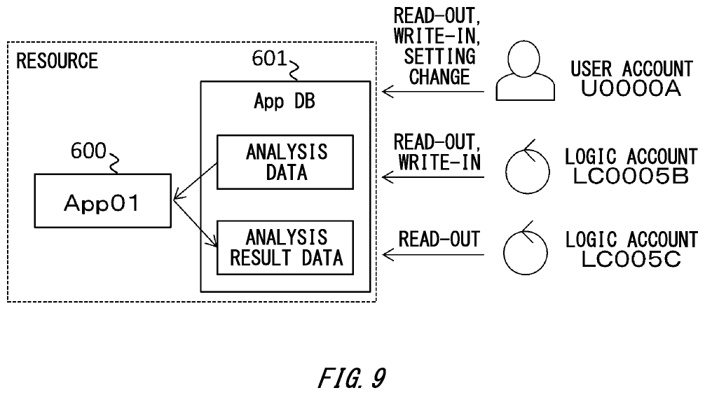

For this resource, a user of a user account “U0000A” has an access right of a role “Owner”, and is allowed to read out data from the application database 601, and change the settings of the network device 5. In addition, a user of a user account “U0000B” has an access right of a role “User”, and is allowed to read out alarm data from the application database 601. In addition, an instance 310 of a logic account “LC005C” has an access right of a role “Reader”, and is allowed to read out data from the application database 601.

[7-2. Specific Example (2)] FIG. 9 illustrates another exemplary aspect in which access to a resource is allowed. In this figure, for example, a resource has an application 600 itself of an ID “App01” to perform data analysis, and an application database 601 that stores analysis target data, and analysis result data.

For this resource, a user of a user account “U0000A” has an access right of a role “Owner”, and is allowed to read out data from the application database 601, write data in the application database 601, and change the settings of an application 600 of “App02”. In addition, an instance of a logic account “LC0005C” has an access right of a role “Contributor”, and is allowed to read out data of the application database 601 and write data in the application database 601. In addition, an instance 310 of a logic account “LC005C” has an access right of a role “Reader”, and is allowed to read out data from the application database 601.

[8. Variant] Note that although, in the embodiment explained above, role-right tables 604 store applicable ranges of access rights, valid periods of access rights (e.g., one month), the numbers of times of valid access (e.g., ten times), or the like may be stored.

In addition, although, in the explanation above, the apparatus 6 has the CPU 61, registering unit 62, verifying unit 63, instruction input unit 64, setting unit 65, and applications 600, it may not have at least one of them. For example, these configurations may be provided to an external instrument connected to the apparatus 6.

In addition, although, in the explanation above, a storage unit 30 of a service providing apparatus 3 stores execution logics 300, in addition to this, it may store a right to access resources of the service providing apparatus 3. For example, the storage unit 30 may store an access right for each instance to access a resource of the service providing apparatus 3. The storage unit 30 may store an access right in a manner similar to that for the storage unit 60 of the apparatus 6, and may store a role database and a role-right table similar to the role database 603 and role-right tables 604, for example.

In addition, although, in the explanation above, an application 600 utilizes a service executed by an execution logic 300, the application 600 itself may be an execution logic to provide a service. In this case, a service providing apparatus 3 to utilize a service provided by the application 600 through an instance 310 of an execution logic 300 may store an access right for each instance (e.g., for each execution application 610) to access a resource of the service providing apparatus 3.

In addition, although, in the explanation above, the storage unit 60 stores, in the role database 603, a role of an access right for each logic account, and stores, in a role-right table 604, an access right for each role, it may store an access right for each logic account without using a role.

In addition, although, in the explanation above, applicable ranges of access rights are stored in the role database 603, and role-right tables 604, they may be stored only in one of them.

Various embodiments of the present invention may be described with reference to flowcharts and block diagrams whose blocks may represent (1) steps of processes in which operations are performed or (2) sections of apparatuses responsible for performing operations. Certain steps and sections may be implemented by dedicated circuitry, programmable circuitry supplied with computer-readable instructions stored on computer-readable media, and/or processors supplied with computer-readable instructions stored on computer-readable media. Dedicated circuitry may include digital and/or analog hardware circuits and may include integrated circuits (IC) and/or discrete circuits. Programmable circuitry may include reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Computer-readable media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable media may include an electronic storage medium, a magnetic storage medium, an optical storage medium, an electromagnetic storage medium, a semiconductor storage medium, etc. More specific examples of computer-readable media may include a floppy disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY® disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., to execute the computer-readable instructions to create means for performing operations specified in the flowcharts or block diagrams. Examples of processors include computer processors, processing units, microprocessors, digital signal processors, controllers, microcontrollers, etc.

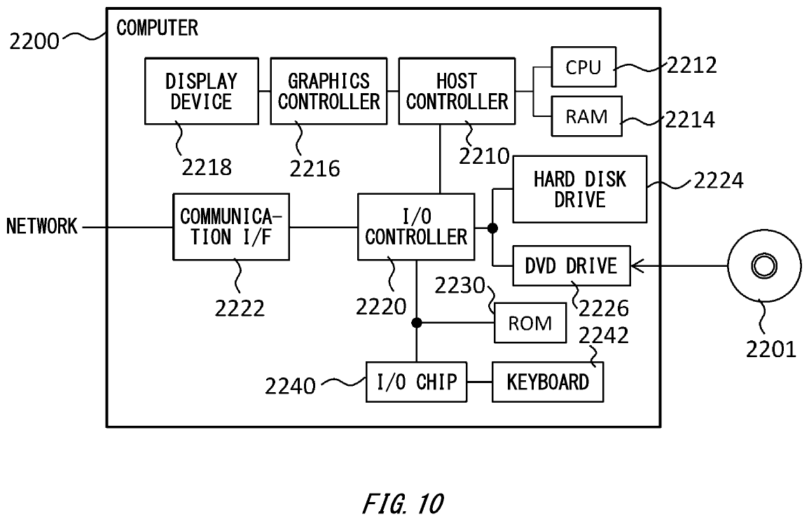

FIG. 10 shows an example of a computer 2200 in which aspects of the present invention may be wholly or partly embodied. A program that is installed in the computer 2200 can cause the computer 2200 to function as or perform operations associated with apparatuses of the embodiments of the present invention or one or more sections thereof, and/or cause the computer 2200 to perform processes of the embodiments of the present invention or steps thereof. Such a program may be executed by the CPU 2212 to cause the computer 2200 to perform certain operations associated with some or all of the blocks of flowcharts and block diagrams described herein.

The computer 2200 according to the present embodiment includes a CPU 2212, a RAM 2214, a graphics controller 2216, and a display device 2218, which are mutually connected by a host controller 2210. The computer 2200 also includes input/output units such as a communication interface 2222, a hard disk drive 2224, a DVD-ROM drive 2226 and an IC card drive, which are connected to the host controller 2210 via an input/output controller 2220. The computer also includes legacy input/output units such as a ROM 2230 and a keyboard 2242, which are connected to the input/output controller 2220 through an input/output chip 2240.

The CPU 2212 operates according to programs stored in the ROM 2230 and the RAM 2214, thereby controlling each unit. The graphics controller 2216 obtains image data generated by the CPU 2212 on a frame buffer or the like provided in the RAM 2214 or in itself, and causes the image data to be displayed on the display device 2218.

The communication interface 2222 communicates with other electronic devices via a network. The hard disk drive 2224 stores programs and data used by the CPU 2212 within the computer 2200. The DVD-ROM drive 2226 reads the programs or the data from the DVD-ROM 2201, and provides the hard disk drive 2224 with the programs or the data via the RAM 2214. The IC card drive reads programs and data from an IC card, and/or writes programs and data into the IC card.

The ROM 2230 stores therein a boot program or the like executed by the computer 2200 at the time of activation, and/or a program depending on the hardware of the computer 2200. The input/output chip 2240 may also connect various input/output units via a parallel port, a serial port, a keyboard port, a mouse port, and the like to the input/output controller 2220.

A program is provided by computer readable media such as the DVD-ROM 2201 or the IC card. The program is read from the computer readable media, installed into the hard disk drive 2224, RAM 2214, or ROM 2230, which are also examples of computer readable media, and executed by the CPU 2212. The information processing described in these programs is read into the computer 2200, resulting in cooperation between a program and the above-mentioned various types of hardware resources. An apparatus or method may be constituted by realizing the operation or processing of information in accordance with the usage of the computer 2200.

For example, when communication is performed between the computer 2200 and an external device, the CPU 2212 may execute a communication program loaded onto the RAM 2214 to instruct communication processing to the communication interface 2222, based on the processing described in the communication program. The communication interface 2222, under control of the CPU 2212, reads transmission data stored on a transmission buffering region provided in a recording medium such as the RAM 2214, the hard disk drive 2224, the DVD-ROM 2201, or the IC card, and transmits the read transmission data to a network or writes reception data received from a network to a reception buffering region or the like provided on the recording medium.

In addition, the CPU 1212 may cause all or a necessary portion of a file or a database to be read into the RAM 1214, the file or the database having been stored in an external recording medium such as the hard disk drive 1224, the DVD-ROM drive 1226 (DVD-ROM 1201), the IC card, etc., and perform various types of processing on the data on the RAM 1214. The CPU 2212 may then write back the processed data to the external recording medium.

Various types of information, such as various types of programs, data, tables, and databases, may be stored in the recording medium to undergo information processing. The CPU 2212 may perform various types of processing on the data read from the RAM 2214, which includes various types of operations, processing of information, condition judging, conditional branch, unconditional branch, search/replace of information, etc., as described throughout this disclosure and designated by an instruction sequence of programs, and writes the result back to the RAM 2214. In addition, the CPU 2212 may search for information in a file, a database, etc., in the recording medium. For example, when a plurality of entries, each having an attribute value of a first attribute associated with an attribute value of a second attribute, are stored in the recording medium, the CPU 2212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable media on or near the computer 2200. In addition, a recording medium such as a hard disk or a RAM provided in a server system connected to a dedicated communication network or the Internet can be used as the computer readable media, thereby providing the program to the computer 2200 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### REFERENCE SIGNS LIST

1: system;

2: client terminal;

3: service providing apparatus;

5: network device;

6: apparatus;

11: network;

12: network;

30: storage unit;

31: CPU;

60: storage unit;

61: CPU;

62: registering unit;

63: verifying unit;

64: instruction input unit;

65: setting unit;

66: access control unit;

300: execution logic;

310: instance;

600: application;

601: application database;

602: verification database;

603: role database;

604: role-right table;

605: logic database;

610: execution application;

2200: computer;

2201: DVD-ROM;

2210: host controller;

2212: CPU;

2214: RAM;

2216: graphics controller;

2218: display device;

2220: input/output controller;

2222: communication interface;

2224: hard disk drive;

2226: DVD-ROM drive;

2230: ROM;

2240: input/output chip;

2242: keyboards

What is claimed is:

1. An apparatus comprising:
a storage unit that, for each of instances of a plurality of execution logics to execute a service on one or more service providing apparatuses in communication with the apparatus through a network, stores a right to access a resource stored in the storage unit allocated to the instance; and
an access control unit that allows each instance to access the resource within a range of the access right.

2. The apparatus according to claim 1, wherein the storage unit stores an application to utilize the service.

3. The apparatus according to claim 1, wherein different instances are associated with different combinations of an execution logic and a user account that causes the execution logic to be executed.

4. The apparatus according to claim 1, comprising a verifying unit that performs verification of each of logic accounts allocated to the instances of the plurality of execution logics, wherein
the access control unit allows an instance of a logic account that is successfully verified by the verifying unit to access the resource.

5. The apparatus according to claim 1, wherein
the storage unit stores the access right as a role, and
the access control unit allows access within a range of the access right corresponding to the role.

6. The apparatus according to claim 1, wherein the access right indicates whether or not at least one of a right to read out data from the resource, a right to write data in the resource, and a right to change a setting of the resource is given.

7. The apparatus according to claim 6, wherein the access right further indicates an address range in the resource that is allowed for at least one of the right to read out data, and the right to write data.

8. A method comprising:
for each of instances of a plurality of execution logics to execute a service on one or more service providing apparatuses in communication with an apparatus through a network, storing, by the apparatus, a right to access a resource stored in the apparatus allocated to the instance; and
allowing, by the apparatus, each instance to access the resource within a range of the access right.

9. A non-transitory computer-readable recording medium having recorded thereon a program that, when executed by a computer, causes the computer to perform operations comprising:
for each of instances of a plurality of execution logics to execute a service on one or more service providing apparatuses in communication with the computer through a network, storing, by the computer, a right to access a resource stored in the computer allocated to the instance; and
allowing, by the computer, each instance to access the resource within a range of the access right.
